(19) United States
(12) Patent Application Publication
(10) Pub. No.: US 2010/0170296 A1
(43) Pub. Date: Jul. 8, 2010

(54) SEPARATION OF VOLATILE COMPONENTS FROM A GAS FLOW

(76) Inventors: Stefan Wolf, Haar (DE); Ron C. Lee, Bloomsbury, NJ (US)

Correspondence Address: The BOC Group, Inc., 575 MOUNTAIN AVENUE, MURRAY HILL, NJ, 07974-2082, US

(21) Appl. No.: 12/684,202

(22) Filed: Jan. 8, 2010

(30) Foreign Application Priority Data
Jan. 8, 2009 (DE) 102009004106.0

(51) Int. Cl. C02F 1/22

(52) U.S. Cl. 62/532

(57) ABSTRACT

Methods of separating volatile organic and/or gaseous inorganic components from a gas mixture, comprising subjecting the gas mixture to a cryocondensation process and an adsorption process to separate the volatile organic and/or gaseous inorganic components. The adsorption process utilizes at least two parallel adsorbers running alternately through adsorption and desorption phases. A regeneration gas used for the desorption phase is added to the gas mixture prior to the cryocondensation process. Temperature of the condensation process may be varied.

### CROSS REFERENCE TO RELATED APPLICATIONS

This application claims priority from German Patent Application Serial No. DE 10 2009 004 106.0, filed Jan. 8, 2009.

### DESCRIPTION

The invention relates to a method for the separation of volatile organic and/or gaseous inorganic components from a gas mixture containing volatile organic and/or gaseous inorganic components,
wherein said gas mixture is subjected to a cryocondensation process serving to separate the volatile organic and/or gaseous inorganic components and then to an adsorption process serving to separate the volatile organic components,
wherein the adsorption process takes place in at least two adsorbers arranged in parallel, which run alternately through adsorption and desorption phases and
the regeneration gas conveyed during a desorption phase through an adsorber and loaded with volatile organic and/or gaseous inorganic components is added at least partially to the gas mixture containing volatile organic and/or gaseous inorganic components before it is fed into the cryocondensation process.

According to the definition of the WHO, the term “volatile organic components” is understood to mean all organic compounds with boiling points in the temperature range from 50 to 260° C. In Germany, an organic component is referred to as volatile in the 31. BlmscV [31st Federal Emission Protection Ordinance] if it has a vapour pressure of at least 0.01 kilopascal at a temperature of 293.15 K or a corresponding volatility under the given conditions of use. Solvents, such as for example acetone, toluene, dichloromethane and methanol, are mentioned merely by way of example. Gaseous inorganic substances are for example hydrogen chloride, hydrogen bromide and ammonia.

Generic methods for the separation of volatile organic and/or gaseous inorganic components from a gas mixture are used in a large number of cases of application. For example, in the recovery of volatile organic and/or gaseous inorganic components from the waste gas from tankers, which arises during the filling procedure of such tankers. On account of correspondingly stringent requirements and statutory regulations, it is necessary to reduce the proportion of volatile organic and/or gaseous inorganic components in such (waste) gas mixtures to a content of, for example, less than 20 mg/Nm³. In Germany, the limiting values, which differ depending on the substance class, are legally stipulated in the Clean Air Act.

### BRIEF DESCRIPTION OF THE DRAWINGS

FIG. 1 is a schematic drawing of components and process stages used in one embodiment according to the present invention.

FIG. 2 is a schematic drawing of components and process stages used in a further embodiment according to the present invention.

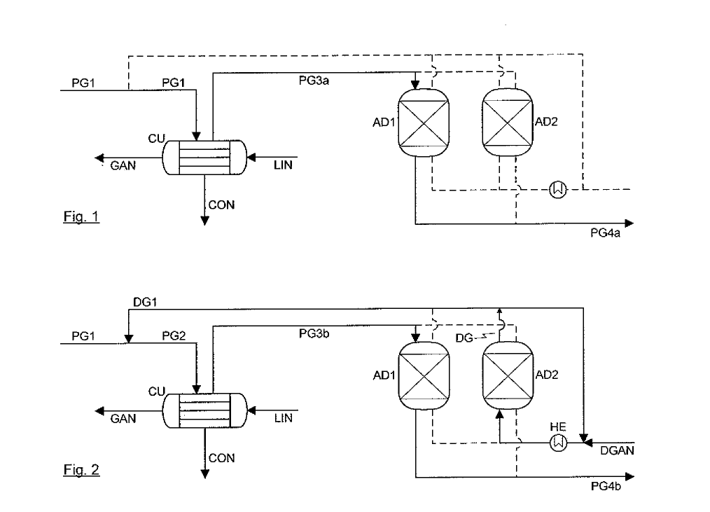

Generic methods and the method according to the invention for the separation of volatile organic and/or gaseous inorganic components from a gas mixture will be explained in greater detail below with the aid of the example of embodiment represented in FIGS. 1 and 2.

The gas mixture containing volatile organic and/or gaseous inorganic components—referred to in the following as the PG1 flow—is fed to a cryocondensation process CU, as represented in FIG. 1. In such cryocondensation processes, single- or multi-stage cooling of the gas mixture takes place to a temperature at which the volatile organic and/or gaseous inorganic components to be removed condense. The condensate arising within the cryocondensation process—referred to in the following as the CON flow—is removed from the cryocondensation process and discarded or, as the case may be, subjected to further treatment.

The cooling of the PG1 flow takes place in one or more heat exchangers against one or more refrigerants and/or refrigerant mixtures. The latter is or are denoted in FIGS. 1 and 2 as the LIN flow. The heated refrigerant (mixture) flow removed from the cryocondensation process is referred to as the GAN flow. As a rule, either cryogenic gaseous nitrogen or liquid nitrogen is used as a refrigerant. In the case of preliminary cooling of the PG1 flow (not represented in FIGS. 1 and 2), the purified flow removed from the cryocondensation process—referred to in the following as the PG3a or PG3b flow—can if necessary also be used.

Compared to the PG1 flow, the PG3a flow removed from the cryocondensation process has a much lower proportion of volatile organic and/or gaseous inorganic components. Its composition depends both on the composition of the PG1 flow as well as the pressure and temperature within the cryocondensation process. Since the observance of strict requirements concerning the proportions of volatile organic and/or gaseous inorganic components cannot as a rule be achieved by the exclusive provision of a cryocondensation process, adsorptive post-purification of the PG3a flow removed from the cryocondensation process is carried out. The adsorption processes used for this comprise two or more adsorbers AD1 and AD2 arranged in parallel. Activated carbons, zeolites and/or activated aluminium oxides are used as adsorbents. By means of the adsorption process downstream of the cryocondensation process, it is possible to remove approximately 100% of the volatile organic and/or gaseous inorganic components from the PG1 and PG3a/b flow.

As shown in FIG. 1, the PG3a flow is conveyed through adsorber AD1 until its adsorbent is completely loaded. During the adsorption phase in adsorber AD1, the gas mixture purified of volatile organic and/or gaseous inorganic components—referred to in the following as the PG4a flow—is removed and passed on for its further use. The relatively low temperature of the PG3a/b flow is advantageous for efficient adsorption of the volatile organic and/or gaseous inorganic components. As soon as the capacity of adsorber AD1 is exhausted after the lapse of total adsorption time TAT, the supply of the PG3a flow to adsorber AD1 is stopped and the PG3a flow is now fed to adsorber AD2. Loaded adsorber AD2 must however be regenerated beforehand. This is represented in FIG. 2.

A suitable regeneration gas flow—referred to in the following as the DGAN flow—is conveyed through adsorber AD2, preferably in the opposite direction to the flow direction prevailing during the adsorption phase. An inert gas, such as for example nitrogen, is as a rule used as the regeneration gas. The DGAN flow is heated by means of a heating device HE, which is arranged upstream of adsorber AD2 in the flow direction of the DGAN flow. The DGAN flow entering into adsorber AD2 usually has a temperature between 50 and 200° C. This desorption temperature depends, amongst other things, on the desorption behaviour of the organic and/or gaseous inorganic components and the adsorbent used.

As a result of the heating of the adsorbent to be regenerated, the adsorbed volatile organic and/or gaseous inorganic components are desorbed and carried along with the regeneration gas flow which is exiting from adsorber AD2 and which, after exit from adsorber AD2, is referred to in the following as the DG flow. Part of the DG flow can, as represented in FIG. 2, be returned before adsorber AD2 and added to the DGAN flow before heater HE. This mode of procedure makes it possible to bring adsorber AD2 to the required desorption temperature in a short time through the circulation process, since the circulation gas is continuously heated by heating device HE. It is possible by means of the circulation process to operate with a small DGAN flow, which leads to low operating costs for the regeneration.

In order to equalise the mass balance, a partial flow of the DG flow—which is referred to in the following as the DG1 flow—has to be returned before the cryocondensation process. During the desorption phase of adsorber AD2, therefore, the DG1 flow is mixed with the PG1 flow. The mixed flow is referred to in the following as the PG2 flow. The return of the DG1 flow before the cryocondensation process is continued during desorption time DT until adsorber AD2 is completely regenerated and essentially free from volatile organic and/or gaseous inorganic compounds. After completion of the desorption phase, adsorber AD2 is cooled down to the low temperature required for the following adsorption phase. This takes place, for example, by passing liquid nitrogen over the previously regenerated adsorption bed of adsorber AD2.

As a rule, the adsorption and the desorption are time-controlled. After the termination of total adsorption time TAT, the PG3a/b flow, which is first fed to adsorber AD1, is diverted to second adsorber AD2. At the same time, the desorption phase for loaded adsorber AD1 begins. It is evident that the adsorption process described above can only function when desorption time DT is shorter than total adsorption time TAT. Both times DT and TAT are influenced by a large number of parameters, such as for example temperature, pressure, type of volatile organic and/or gaseous inorganic components, composition of gas mixture PG1, etc.

While an adsorber is running through adsorption phase TAT, a distinction is made between two modes of procedure. In the first place, only the PG3a flow is fed to the adsorption process. During this time, no desorption takes place in adsorber AD2. If second adsorber AD2 is regenerated, the PG3b flow is fed to adsorber AD1. The latter is composed of the PG1 and DG1 flows fed to the cryocondensation process. The duration of the first adsorption phase described above, during which no regeneration takes place, is referred to in the following as AT1, whilst the adsorption time during which regeneration takes place is referred to as AT2. The following holds here: AT2=DT.

The procedural combination of cryocondensation process and adsorption process described above only functions, however, when the adsorption capacity of the adsorber present in the adsorption phase is not already exhausted within adsorption time TAT. If this were the case, the volatile organic and/or gaseous inorganic components of the gas mixture to be purified would break through the adsorber present in the adsorption phase. The concentration of volatile organic and/or gaseous inorganic components in the PG4a and PG4b flow must not however exceed the permitted limiting values. As soon as this were the case, the process would have to be interrupted. Since such processes are often incorporated into filling and production installations, the effect of switching off these installation units would be that the whole installation would possibly have to be shut down.

The overall process is essentially determined by the cryocondensation process being carried out. In particular, the condensation temperature T-CU that is reached determines the quantity of condensed volatile organic and/or gaseous inorganic components as well as the quantity of these components that is fed with the PG3a/b flow to the adsorption process. The condensation temperatures of cryocondensation processes usually lie between −40 and −160° C.

If the condensation temperature is selected too high, the effect of this is that the volatile organic and/or gaseous inorganic components become enriched in the PG3a/b flow during the process. The effect of this in turn is that the adsorber present in adsorption is loaded too quickly. Since adsorption time TAT is preset, the maximum capacity of the adsorber is reached before the expiry of adsorption time TAT and a breakthrough of the volatile organic and/or gaseous inorganic components through the adsorber occurs. The composition of the PG3a/b flow is essentially determined by the selected condensation temperature. However, the composition of the PG1 flow, which as a rule is preset, and the composition of the DG1 flow also influence the composition of the PG3a/b flow. This situation is explained below with the aid of example 1; here, the abbreviation VC stands for the volatile organic and/or gaseous inorganic components contained in the gas mixture to be purified.

### Example 1

PG1 contains 2 kg/h VCs. DG1=0.2 kg/h VCs thus flow into cryocondensation process CU. 50% of the VCs are condensed at a condensation temperature T-CU. 1 kg/h VCs thus flow into adsorber AD1, in which they are completely adsorbed. The maximum capacity of AD1 amounts to 12 kg VCs, which corresponds to an adsorption time TAT of 12 h. DT (=AT2) amounts to 6 h. DG1 contains 2 kg/h VCs in order to be able to desorb 12 kg VCs from adsorber AD2 within 6 h. During the 6 h desorption, PG2 thus contains 3 kg/h VCs (composed of 1 kg/h VCs in PG1 and 2 kg/h VCs in DG1). 1.5 kg/h VCs pass into AD1; this means a 50% separation rate of the VCs in CU. After 6 h desorption, 9 kg VCs are adsorbed in AD1. The remaining capacity of AD1 amounts to 3 kg VCs for the 6 h adsorption time AT1 for PG3a. A breakthrough of VCs thus already takes place after 3 h adsorption of PG3a.

An enrichment of the volatile organic and/or gaseous inorganic components can only be avoided by the fact that a lower condensation temperature T-CU is selected. In order to determine the required lowest condensation temperature T-CU, a so-called worst-case scenario is assumed. This occurs when the DG1 flow consists solely of the actual regeneration gas and a component VC1. Here, component VC1 will be the volatile organic and/or gaseous inorganic component with the highest vapour pressure of all the volatile organic and/or gaseous inorganic components contained in gas mixture PG1 to be purified. This DG1 flow is mixed with the PG1 flow to form the PG2 flow before being fed into cryocondensation process CU. The average flow of VCs of the PG3a/b flow to adsorber AD1 during adsorption phase TAT is now calculated. In the case of aforementioned example 1, this would be 12 kg VC (maximum capacity of adsorber AD1) within the 12-hour adsorption time TAT. The average flow of the VCs of the PG3b flow amounts to 1 kg/h during adsorption phase AT2.

Finally, condensation temperature T-CU for the PG3b flow is determined for the worst-case scenario in order to fall below the maximum permissible mass flow of VC of the PG3b flow to adsorber AD1, which in this case must be ≦1 kg/h VC. During the time in which no DG1 flow is returned before the cryocondensation process, only the PG1 flow flows into the cryocondensation process. At a condensation temperature T-CU, the mass flow of the VC of the PG3a flow to adsorber AD1 is less than 1 kg/h, because in the worst-case scenario the PG1 flow contains a smaller proportion of component VC1 than does the PG2 flow. As a result, this leads to an average mass flow of the VCs to adsorber AD1 during adsorption phase TAT that is less than the permissible average mass flow of VCs. The whole process can thus proceed without problem.

Selected condensation temperature T-CU is usually kept constant during total adsorption phase TAT. If the PG1 flow contains a large proportion of readily volatilising organic and/or gaseous inorganic components VC1, a comparatively low condensation temperature is required in order to maintain a low mass flow of VCs in the PG3a flow. In order to achieve such low condensation temperatures, larger refrigerant quantities are required. This gives rise to higher operating costs, especially when the evaporated refrigerant cannot be reused or be used for other purposes.

Moreover, a low condensation temperature promotes the undesired formation of ice in the heat exchanger or exchangers of the condensation process. This ice formation is caused by the components whose melting points lie above the selected condensation temperature. The formed ice, however, reduces the heat transfer in the heat exchanger or exchangers. As a result, the required refrigerating capacity may not be achieved and the desired condensation temperature cannot be adhered to. As a consequence of this, the proportion of the VCs in the PG3a/b flow fed to adsorber AD1 increases.

In addition, the ice formation described above increases the pressure drop over the cryocondensation process. The through-flow of the PG1/2 flow through the heat exchanger or exchangers of the cryocondensation process diminishes and in the worst case is even interrupted. To avoid this, redundant heat exchangers have to be provided in order to ensure a continuous process. While the heat exchanger or exchangers in operation are used for purifying the PG1/2 flow, the heat exchangers not in operation can be defrosted and then be cooled down again. Such a mode of procedure, however, leads to much higher investment and operating costs

The problem of the present invention is to provide a generic method for the separation of volatile organic and/or gaseous inorganic components from a gas mixture, said method avoiding the aforementioned drawbacks.

To solve this problem, a generic method for the separation of volatile organic and/or gaseous inorganic components from a gas mixture is proposed, which is characterised in that the condensation temperature produced within the cryocondensation process varies.

Further advantageous embodiments of the method according to the invention for the separation of volatile organic and/or gaseous inorganic components from a gas mixture, which represent subject-matters of the dependent claims, are characterised in that
the condensation temperature produced within the cryocondensation process is determined by the quantity of the volatile organic and/or gaseous inorganic components contained in the regeneration gas loaded with volatile organic and/or gaseous inorganic components,
the condensation temperature produced within the cryocondensation process is determined, apart from by the parameter “quantity of volatile organic and/or gaseous inorganic components contained in the regeneration gas”, by at least one other process parameter, such as for example pressure, temperature, type of volatile organic and/or gaseous inorganic components, composition of the gas mixture, etc., and
the condensation temperature produced within the cryocondensation process is changed once or repeatedly during an adsorption phase carried out in the adsorption process.

According to the invention, the condensation temperature produced within the cryocondensation process is no longer held down constant during adsorption phase TAT, but rather is varied. This time-dependent, flexible condensation temperature will be referred to below as T-CUx. It is determined for example by the composition of the PG1/2 flow prevailing at the onset of the cryocondensation process. Flexible condensation temperature T-CUx can be changed once or repeatedly during an adsorption phase TAT. Thus, different condensation temperatures can be produced for example during the supply of the PG3a and the PG3b flow
i.e. during adsorption phases TA1 and TA2. If the condensation temperature is changed, it must be ensured that the average mass flow of the volatile organic and/or gaseous inorganic components (VCs) in the flow fed to the adsorption process is lower than the permissible average mass flow of the VCs that is required to operate the adsorption process continuously.

The method according to the invention for the separation of volatile organic and/or gaseous inorganic components from a gas mixture will be explained in greater detail below with the aid of examples 2 and 3.

### Example 2

| | |
|---|---|
| Adsorption capacity of AD1/2: | 3.6 kg VCs |
| Total adsorption time TAT: | 12 h |
| Adsorption time AT1 and AT2: | in each case 6 h |
| Desorption time: | 6 h |
| Volume flow of PG1: | 150 Nm³/h |
| Temperature of PG1: | 25° C. |
| Pressure of PG1: | 1 bar (a) |

| | | Melting | Vapour pressure |
|---|---|---|---|
| PG1 components | Mass flow | point | (25° C.) |
| Nitrogen N₂ | 187.0 kg/h | | |
| Hydrogen | 0.2 kg/h | −114.8° C. | 0.4 bar (a) |
| chloride HCl | | | |
| Dichloromethane | 1.0 kg/h | −96.7° C. | 47.9 bar (a) |
| DCM | | | |

As explained above, the lowest condensation temperature T-CUx is required when the DG1 flow consists exclusively of the regeneration-gas or DGAN flow and the VC components with the highest vapour pressure. This is HCl in example 2.

The HCl mass flow in the DG1 flow must amount to 0.6 kg/h in order to desorb 3.6 kg of the adsorbed HCls which was adsorbed during adsorption time AT2 in adsorber AD2.

| Volume of DG: | 6 | Nm³/h |
|---|---|---|
| Temperature of DG: | 150° | C. |
| Pressure of DG: | 1 | bar (a) |
| DG components | Mass flow | |
| N₂ | 7.0 | kg/h |
| HCl | 0.6 | kg/h |
| Volume of PG2: | 156 | Nm³/h |
| Temperature of PG2: | 30° | C. |
| Pressure of PG2: | 1 | bar (a) |
| PG2 components | Mass flow | |
| N₂ | 194.0 | kg/h |
| HCl | 0.8 | kg/h |
| DCM | 1.0 | kg/h |

The condensation temperature would usually be selected so low during the whole process that adsorber AD1 would not be completely loaded at the end of adsorption time TAT. In the present example, condensation temperature T-CU amounts to −151° C. in order to achieve an HCl and DCM mass flow of 0.3 kg/h to adsorber AD1 during adsorption time TA2. The PG2 flow is cooled to a temperature of −151° C. in cryocondensation process CU. Component DCM condenses completely at this temperature, so that the PG3b flow fed to adsorber AD1 now contains components HCl and N₂.

| Volume of PG3b: | | 155.4 | Nm³/h |
|---|---|---|---|
| Temperature of PG3b: | | −151° | C. |
| Pressure of PG3b: | | 1 | bar (a) |
| PG3b components | Mass flow | Ice formation in CU | |
| N₂ | 194.0 kg/h | 0 | kg/h |
| HCl | 0.3 kg/h | 0.49 | kg/h |
| DCM | 0 kg/h | 0.07 | kg/h |

| | | |
|---|---|---|
| Refrigerating capacity: | 10.4 | kW |
| GAN temperature: | −20° | C. |

| | |
|---|---|
| Required refrigerant | 110.0 kg/h at 6 bar (a) |
| quantity (LIN): | and −172° C. |

After 6 h adsorption of the PG3b flow at adsorber AD1:

| | |
|---|---|
| Total mass of VCs in AD1: | 1.8 kg |
| HCl mass in AD1: | 1.8 kg |
| DCM mass in AD1: | 0 kg |
| Ice in the CU: | 3.36 kg |

After 6 h adsorption of the PG3b flow at adsorber AD1, a VC capacity of 1.8 kg thus remains for the remaining 6-hour adsorption time TA1 of the PG3a flow. The selected condensation temperature of −151° C. is usually not changed during adsorption time TA1.

| Volume of PG3a: | | 150 | Nm³/h |
|---|---|---|---|
| Temperature of PG3a: | | −151° | C. |
| Pressure of PG3a: | | 1 | bar (a) |
| PG3a components | Mass flow | Ice formation in CU | |
| N₂ | 187.0 kg/h | 0 | kg/h |
| HCl | 0.1 kg/h | 0.10 | kg/h |
| DCM | 0 kg/h | 0.07 | kg/h |

| | | |
|---|---|---|
| Refrigerating capacity: | 9.7 | kW |
| GAN temperature: | −25° | C. |

| | |
|---|---|
| Required refrigerant | 104.0 kg/h at 6 bar (a) |
| quantity (LIN): | and −172° C. |

After 6 h adsorption of the PG3a flow at adsorber AD1:

| | |
|---|---|
| Total mass of VCs in AD1: | 0.6 kg |
| HCl mass in AD1: | 0.6 kg |
| DCM mass in AD1: | 0 kg |
| Ice in the CU: | 1.02 kg |

If the results of the respective 6-hour adsorption times TA1 and TA2 are added up (T-UC: −151° C.), the following results:

| | |
|---|---|
| Total mass of VCs in AD1: | 2.4 kg |
| HCl mass in AD1: | 2.4 kg |
| DCM mass in AD1: | 0 kg |
| Ice in the CU: | 4.38 kg |
| Required refrigerant | 1284 kg |
| quantity (LIN): | |

At the end of adsorption time TAT, a VC capacity of 1.2 kg thus remains in adsorber AD1. The whole process thus runs continuously and without problem in respect of the adsorption of components HCl and DCM. The selected condensation temperature of −151° C. leads to ice formation in the cryocondensation process amounting to 4.38 kg during adsorption time TAT. Redundant heat exchangers would therefore have to be provided with the process managed in this way. The required refrigerant quantity of liquid nitrogen amounts to 1284 kg.

A substantial improvement to the method is achieved when condensation temperature T-CU is handled flexibly in terms of time and is changed once or repeatedly during total adsorption time TAT.

### Example 3

Condensation temperature T-CUx is now increased from −151° C. to −94° C. during the 6-hour adsorption time TA1. The effect of this is that the VC mass flow is increased from 0.1 kg/h to 0.3 kg/h in the PG3a* flow.

| Volume of PG3a*: | | 150 | Nm³/h |
|---|---|---|---|
| Temperature of PG3a*: | | −94° | C. |
| Pressure of PG3a*: | | 1 | bar (a) |
| PG3a* components | Mass flow | Ice formation in CU | |
| N₂ | 187.0 kg/h | 0 | kg/h |
| HCl | 0.2 kg/h | 0 | kg/h |
| DCM | 0.1 kg/h | 0 | kg/h |

| | | |
|---|---|---|
| GAN temperature: | −25° | C. |
| Refrigerating capacity: | 6.6 | kW |

| | |
|---|---|
| Required refrigerant | 71.0 kg/h at 6 bar (a) |
| quantity (LIN): | and −172° C. |

After 6 h adsorption of the PG3a* flow at adsorber AD1:

| | |
|---|---|
| Total mass of VCs in AD1: | 1.8 kg |
| HCl mass in AD1: | 1.2 kg |
| DCM mass in AD1: | 0.6 kg |
| Ice in the CU: | 0 kg |

If the results of the respective 6-hour adsorption times TA1 (T-CUx: −94° C.) and TA2 (T-CUx: −151° C.) are added up, the following results; the comparison of the modes of procedure represented in examples 2 and 3 discloses the advantages of the mode of procedure according to the invention:

| | | Difference compared to |
|---|---|---|
| | | the results with T-CU = |
| | | −151° C. |
| Total mass of | 3.6 kg | +33.3% |
| VCs in AD1: | | |
| HCl mass in AD1: | 3.0 kg | +20% |
| DCM mass in AD1: | 0.6 kg | no DCM at T-CU = |
| | | −151° C. |
| Ice in the CU: | 3.36 kg | −23.3% |
| Required | 1086.0 kg | −15.4% |
| refrigerant | | |
| quantity (LIN): | | |

With a condensation temperature of −94° C., 0.3 kg/h VCs are fed to adsorber AD1 with the PG3a* flow. The adsorption capacity of the adsorber of 3.6 kg VCs is used up 100% at the end of total adsorption time TAT. The process according to the invention with a condensation temperature flexible over time therefore uses the adsorption capacity of the adsorber of the downstream adsorption process more effectively. Furthermore, the quantity of refrigerant required for the cryocondensation process is reduced. The ice formation in the heat exchanger or exchangers of the cryocondensation process is also reduced. In the case of example 3, the selected condensation temperature is above the freezing point of components HCl and DCM. Ice formation does not therefore occur during adsorption time TA1. The deicing effect occurring at a condensation temperature of −94° C. is of particular importance, by reason of which the ice formed during the time at which the condensation temperature is selected lower is reduced or completely eliminated. On account of this deicing effect, redundant heat exchangers now no longer have to be provided. The investment costs of the method according to the invention are therefore significantly lower.

With the method described with the aid of example 3, the condensation temperature is changed only once during total adsorption time TAT. Modes of procedure can however also be implemented in which the condensation temperature is changed on a number of occasions during total adsorption time TAT. Even more effective purification processes can be achieved with such modes of procedure. It is true of all temperature changes that it must be ensured that the total quantity of the VCs adsorbed at an adsorber during total adsorption time TAT is less than and equal to the VC capacity of the adsorber. This condition leads to the simplified equation reproduced below:

VCs to AD1=VC1(T1)*t1+VC2(T2)*t2+ . . . +VCi(Ti)*ti<VC capacity of AD1

Secondary condition: t1+t2+ . . . +ti=TAT

where
VCi(Ti)=mass flow of the VCs to AD1 at condensation temperature Ti in the CU
Ti=condensation temperature in the CU during time ti
ti=time during which a condensation temperature Ti is held

The combination of high and low condensation temperatures, which of course can last for varying lengths of time, make it possible to create a purification process which is optimised with regard to the adsorption of the volatile organic components, the formation of ice and the consumption of refrigerant.

The method according to the invention for the separation of volatile organic and/or gaseous inorganic components from a gas mixture containing these components now comprises, compared to the prior art, a large number of advantages which are stated below:

The capacity of the adsorption process with regard to the volatile organic components is increased by the provision of a condensation temperature adapted to the process parameters. As a consequence of this, the quantity of adsorbent(s) can be reduced and the adsorbers can be provided with smaller dimensions. The investment costs of the adsorption process can thus be reduced.

Furthermore, the required quantity of refrigerant for the cryocondensation process can be reduced. The lowest condensation temperature does not have to be adhered to during the whole process. The economy of the method according to the invention is increased on account of lower operating costs.

A higher refrigerating capacity can be achieved through the avoidance of undesired ice formation in the heat exchanger or exchangers of the cryocondensation process. In a large number of cases of application, this can be accompanied by dispensing with the redundant heat exchangers that previously had to be provided. Deicing of the heat exchanger or exchangers can if need be also take place at times when the operation is being carried out at higher condensation temperatures.

The control system required for the implementation of the method according to the invention is constituted more simply compared to the control systems of conventional methods, since neither a switch-over between individual, redundant heat exchangers nor defrosting of heat exchangers is necessary.

1. A method for the separation of volatile organic and/or gaseous inorganic components from a gas mixture containing volatile organic and/or gaseous inorganic components,
wherein said gas mixture is subjected to a cryocondensation process serving to separate the volatile organic and/or gaseous inorganic components and then to an adsorption process serving to separate the volatile organic and/or gaseous inorganic components,
wherein the adsorption process takes place in at least two adsorbers arranged in parallel, which run alternately through adsorption and desorption phases and
the regeneration gas conveyed during a desorption phase through an adsorber and loaded with volatile organic and/or gaseous inorganic components is added at least partially to the gas mixture containing volatile organic and/or gaseous inorganic components before it is fed into the cryocondensation process,
characterised in that the condensation temperature (T-CUx) produced within the cryocondensation process (CU) varies.

2. The method according to claim 1, characterised in that the condensation temperature (T-CUx) produced within the cryocondensation process (CU) is determined by the quantity of the volatile organic and/or gaseous inorganic components contained in the regeneration gas (DG1) loaded with volatile organic and/or gaseous inorganic components.

3. The method according to claim 2, characterised in that the condensation temperature (T-CUx) produced within the cryocondensation process (CU) is determined, apart from by the parameter “quantity of . . . in the regeneration gas (DG1) loaded with volatile organic and/or gaseous inorganic components”, by at least one other process parameter.

4. The method according to claim 1, characterised in that the condensation temperature (T-CUx) produced within the cryocondensation process (CU) is changed once or repeatedly during an adsorption phase (TAT) carried out in the adsorption process.
